(19) United States
(12) Patent Application Publication
(10) Pub. No.: US 2004/0230813 A1
(43) Pub. Date: Nov. 18, 2004

(54) Cryptographic coprocessor on a general purpose microprocessor

(75) Inventors: Mark A. Check, Hopewell Junction, NY (US); Jeffrey A. Magee, Poughkeepsie, NY (US); Timothy J. Slegel, Staatsburg, NY (US); Charles F. Webb, Wappingers Falls, NY (US)

Correspondence Address: Lynn L. Augspurger, IBM Corporation, 2455 South Road, P386, Poughkeepsie, NY, 12601, US

(73) Assignee: International Business Machines Corporation, Armonk, NY (US)

(21) Appl. No.: 10/436,222

(22) Filed: May 12, 2003

(51) Int. Cl. H04L 9/00

(52) U.S. Cl. 713/189

(57) ABSTRACT

Cryptographic functions are implemented in execution unit hardware on the CPU of a computer system. This implementation enables a lower latency for calling and executing cryptographic operations and increases the efficiency. This decreased latency greatly enhances the capability of general purpose processors in systems that frequently do many cryptographic operations, particularly when only small amounts of data are involved. This allows an implementation that can significantly accelerate the processes involved in doing secure online transactions.

### FIELD OF THE INVENTION

This invention relates to computer systems.

The invention particularly is directed to methods of secure data transmission in computer systems.

Trademarks: IBM® is a registered trademark of International Business Machines Corporation, Armonk, N.Y., U.S.A. Other names may be registered trademarks or product names of International Business Machines Corporation or other companies.

### BACKGROUND

Previously cryptographic processes have been computed with software or in hardware external to the central processing unit. U.S. Pat. No. 6,047,375 of Apr. 4, 2000 of Randall Easter et al describes IBM's Cryptographic processor with interchangeable units. See also U.S. Pat. No. 6,339,824, entitled “Method and apparatus for providing public key security control for a cryptographic processor, issued Jan. 15, 2002 and U.S. Pat. No. 6,144,744, entitled “Method and apparatus for the secure transfer of objects between cryptographic processors” issued Nov. 7, 2000.

### SUMMARY OF THE INVENTION

A plurality of cryptographic hardware engines assisting accelerated computation of cryptographic algorithm operations are integrated within the central processing unit and these engines decrease the latency with which the operations can be executed relative to any implementation external to the area logically comprising the central processing unit of our computer system.

In accordance with the preferred embodiment of the invention cryptographic functions are implemented in execution unit hardware on the CPU and this implementation enables a lower latency for calling and executing cryptographic operations and increases the efficiency.

These and other improvements are set forth in the following detailed description. For a better understanding of the invention with advantages and features, refer to the description and to the drawings.

### DESCRIPTION OF THE DRAWINGS

FIG. 1, shows schematically a high level overview of the preferred embodiment and particularly shows a block diagram illustrating the components of a central processing unit having a cryptographic coprocessor unit as one of the execution pipelines attached to a data bus common to all execution pipelines in the central processing unit.

FIG. 2, illustrates the cryptographic processing unit of the preferred embodiment in a central processing unit.

Our detailed description explains the preferred embodiments of our invention, together with advantages and features, by way of example with reference to the drawings.

### DETAILED DESCRIPTION OF THE INVENTION

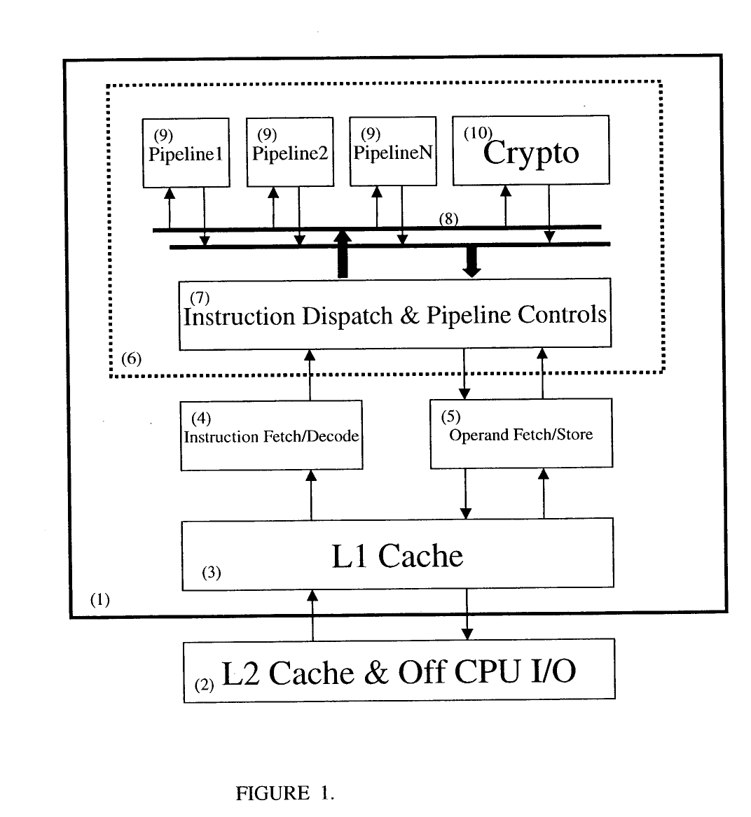

FIG. 1 provides a high level block diagram of a central processing unit (1) in our preferred embodiment, comprising a L1 cache (3) from which instructions are fetched and decoded (4) and presented to the execution unit (6) of the processor. Instruction Dispatch and Pipeline Controls (7) engage various execution pipelines (9) and a cryptographic coprocessor (10) via a microprocessor internal bus (8) common to all execution pipelines. Operand data is fetched and stored via operand fetch/store controls (5). Any data or instructions not available from the L1 cache (3) are requested from the L2 cache (2). L2 cache controls also handle the I/O requests generated from the central processing unit (1). The main purpose of FIG. 1 is to illustrate that the cryptographic engines (10) are an area logically consistent with other execution unit hardware, and not located or accessed via a processor bus logically external to the central processing unit (1).

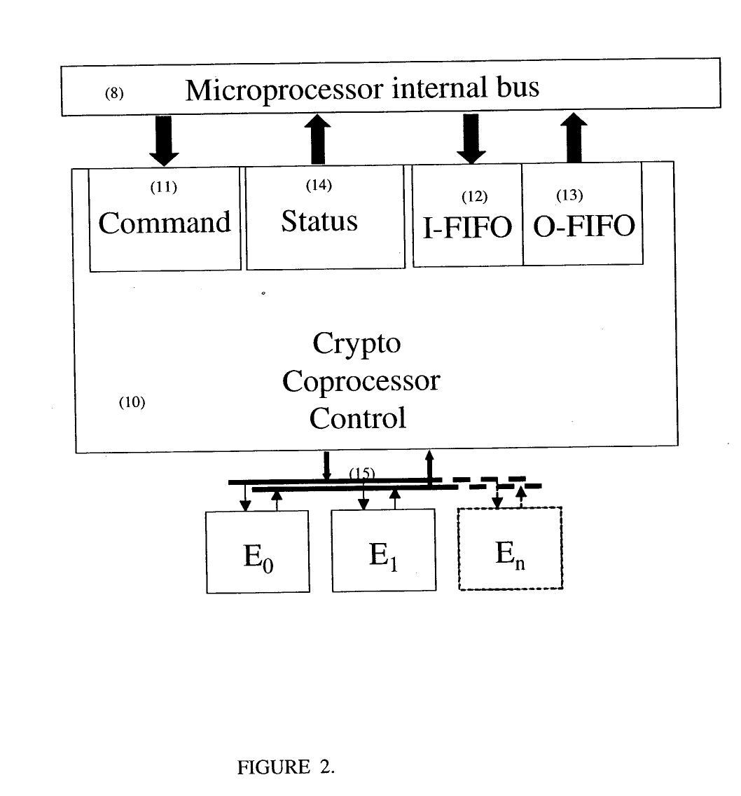

FIG. 2 illustrates our cryptographic coprocessor which is directly attached to a data path common to all internal execution units on a general purpose microprocessor, which has multiple execution pipelines. The microprocessor internal bus (8) is common to all other execution units and is attached to the cryptographic control unit (10), and the control unit watches the bus for processor instructions that it should execute. The cryptographic control unit provides a cryptographic coprocessor directly attached to a data path common to all internal execution units of the central processing unit on a general purpose microprocessor providing the available cryptographic hardware engines (E₀ . . . Eₙ), or from a combination thereof in the preferred embodiment having multiple execution pipelines for the central processing unit. When a cryptographic instruction is encountered in the command register (11), the control unit (10) invokes the appropriate algorithm from the available hardware. The preferred embodiment includes hardware for execution of encryption, decryption and secure hashing functions. Operand data is delivered over the same internal microprocessor bus via an input FIFO register (12). When an operation is completed a flag is set in a status register (14) and the results are available to be read out from the output FIFO register (13).

The illustrated preferred embodiment of our invention is designed to be extensible to include as many hardware engines as required by a particular implementation depending on the performance goals of the system. The data paths to the input and output registers (15) are common among all engines.

In the preferred embodiment of the invention cryptographic functions are implemented in execution unit hardware on the CPU and this implementation enables a lower latency for calling and executing cryptographic operations and increases the efficiency.

This decreased latency greatly enhances the capability of general purpose processors in systems that frequently do many cryptographic operations, particularly when only small amounts of data are involved. This allows an implementation that can significantly accelerate the processes involved in doing secure online transactions. The most common methods of securing online transactions involve a set of three algorithms. The first algorithm is only used one time in a session, and may be implemented in hardware or software, while the other operations are invoked with every transaction of the session, and the cost in latency of calling external hardware as well as the cost in time to execute the algorithm in software are both eliminated with this invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer system comprising:
a central processor having a plurality of cryptographic hardware engines assisting accelerated computation of cryptographic algorithm operations integrated within the central processing unit and directly attached to a data path common to all internal execution units of the central processing unit.

2. The computer system according to claim 1 wherein the central processing unit has a general purpose microprocessor having a cryptographic coprocessor directly attached to a data path common to all internal execution units of the central processing unit and having multiple engines providing available hardware for cryptographic execution of security algorithms when a cryptographic control unit invokes the appropriate algorithm from the available hardware for cryptographic execution.

3. The computer system according to claim 1 wherein a cryptographic coprocessor is directly attached to a data path common to all internal execution units on a general purpose microprocessor to assist in the accelerated computation of cryptographic algorithm operations.

4. The computer system according to claim 1 wherein cryptographic functions are implemented in execution unit hardware on the central processing unit (CPU) and enables a lower latency for calling and executing cryptographic operations.

5. The computer system of claim 1, wherein the central processor unit has a microprocessor internal bus common to all execution units which is attached to a cryptographic control unit having a command register, and the control unit watches the bus for processor instructions that it should execute.

6. The computer system according to claim 1 wherein when a cryptographic instruction is encountered in a command register, a control unit for cryptographic functions invokes an appropriate cryptographic algorithm from the available hardware.

7. The computer system according to claim 1 wherein operand data is delivered over the same data path and over the internal microprocessor bus via an input FIFO register.

8. The computer system according to claim 7, wherein when an operation is completed then a flag is set in a status register and the results are available to be read out from the output FIFO register over the same data path.

9. The computer system according to claim 8 wherein the same data paths for the input and output registers are common among all engines providing available hardware for cryptographic execution of an appropriate cryptographic algorithm from the available hardware.

10. The computer system according to claim 9, wherein cryptographic functions implemented in execution unit available hardware of the central processing unit enables a lower latency for calling and executing cryptographic operations.

11. The computer system according to claim 10 wherein a cryptographic algorithm includes a first algorithm used one time in a session.

12. The computer system according to claim 11 wherein in addition to said first algorithm used one time in a session, other algorithms perform operations that are invoked in every transaction of said session.

13. A method of accelerating cryptographic operations comprising,
using a cryptographic control unit of a general purpose microprocessor a control unit for cryptographic functions to invoke an appropriate cryptographic algorithm from the available hardware.

14. The method of accelerating cryptographic operations according to claim 13 wherein operand data is delivered over the same data path and over an internal microprocessor bus via an input FIFO register.

15. The method of accelerating cryptographic operations according to claim 13 wherein when an operation is completed then a flag is set in a status register and the results are available to be read out from an output FIFO register over the same data path and microprocessor bus.

16. The method of accelerating cryptographic operations according to claim 13 wherein the same data paths for the input and output registers are common among a plurality of cryptographic engines of said general purpose microprocessor providing available hardware for cryptographic execution of an appropriate cryptographic algorithm from the available hardware.

17. The method of accelerating cryptographic operations according to claim 16 wherein cryptographic functions implemented in execution unit available hardware of the central processing unit enables a lower latency for calling and executing cryptographic operations.

18. The method of accelerating cryptographic operations according to claim 17 wherein a cryptographic algorithm includes a first algorithm used one time in a session.

19. The method of accelerating cryptographic operations according to claim 18 wherein in addition to said first algorithm used one time in a session, other algorithms perform operations that are invoked in every transaction of said session.

20. A method of increasing performance in a computer system, comprising executing secure online transactions within a general purpose microprocessor of a central processing unit and therein making the most frequently executed security algorithms invoked in every transaction of a session faster, after executing a first algorithm one time.
